(19) United States
(12) Patent Application Publication
(10) Pub. No.: US 2024/0038276 A1
(43) Pub. Date: Feb. 1, 2024

(54) SYSTEMS AND METHODS FOR PRESENTING VIDEOS AND VIDEO EDITS

(71) Applicant: GoPro, Inc., San Mateo, CA (US)

(72) Inventor: Brice Gilbert, Paris (FR)

(21) Appl. No.: 17/747,654

(22) Filed: May 18, 2022

(51) Int. Cl. G11B 27/34; G11B 27/031

(52) U.S. Cl. CPC G11B 27/34; G11B 27/031

(57) ABSTRACT

A video may have a video progress length. The video progress length of the video may be represented within a graphical user interface. One or more segments of the video progress length may be used to generate a video edit having a video edit progress length. The graphical user interface may be modified to represent the video edit progress length. The graphical user interface may simultaneously present elements that represent the video progress length of the video and the video edit progress length of the video edit.

### FIELD

This disclosure relates to an interface that presents videos and video edits.

### BACKGROUND

A video edit may be generated from a segment of a video. Representing the lengths of both the video and the video edit within a graphical user interface may make the graphical user interface cumbersome to use or difficult to comprehend.

### SUMMARY

This disclosure relates to presenting videos and video edits. Video information, video editing information, and/or other information may be obtained. The video information may define a video having a video progress length. The video edit information may define a video edit of the video. The video edit may include a segment of the video progress length. The video edit may have a video edit progress length. A graphical user interface may be presented. The graphical user interface may include a video timeline element and/or other elements. The video timeline element may represent the video progress length. The graphical user interface may be modified to add a video edit timeline element. The video edit timeline element may represent the video edit progress length.

A system for presenting videos and video edits may include one or more electronic storage, processor, and/or other components. The electronic storage may store video information, information relating to a video, video edit information, information relating to a video edit, information relating to a graphical user interface, information relating to modification of the graphical user interface, and/or other information.

The processor(s) may be configured by machine-readable instructions. Executing the machine-readable instructions may cause the processor(s) to facilitate presenting videos and video edits. The machine-readable instructions may include one or more computer program components. The computer program components may include one or more of a video component, a graphical user interface component, a video edit component, a modification component, and/or other computer program components.

The video component may be configured to obtain video information and/or other information. The video information may define a video. The video may have a video progress length.

The graphical user interface component may be configured to present a graphical user interface. The graphical user interface may include a video timeline element and/or other elements. The video timeline element may represent the video progress length.

In some implementations, the graphical user interface may further include a video edit style element. The video edit style element may enable user selection of a video edit style to create the video edit.

In some implementations, the graphical user interface may further include a video edit duration element. The video edit duration element may enable user selection of the video edit progress length.

In some implementations, the graphical user interface may further include a segment element. The segment element may be positioned with respect to the video timeline element to indicate location of the segment of the video progress length included in the video edit.

The video edit component may be configured to obtain video edit information and/or other information. The video edit information may defining a video edit of the video. The video edit may include a segment of the video progress length. The video edit may have a video edit progress length.

The modification component may be configured to modify the graphical user interface. The graphical user interface may be modified to add a video edit timeline element. The video edit timeline element may represent the video edit progress length.

In some implementations, the video edit timeline element may be positioned adjacent to the video timeline element. In some implementations, the video edit timeline element may be positioned inside the video timeline element.

In some implementations, the video timeline element may include a first bar and the video edit timeline element may include a second bar. The second bar may be smaller than the first bar. In some implementations, the video timeline element may include a single-direction bar and the video edit timeline element may include a circular bar.

In some implementations, playback of the video edit may be indicated via the video edit timeline element. The playback of the video edit may not be indicated via the video timeline element.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates a system for presenting videos and video edits.

FIG. 2 illustrates a method for presenting videos and video edits.

FIG. 3A illustrates an example view of a graphical user interface.

FIG. 3B illustrates an example view of a graphical user interface.

FIG. 3C illustrates an example view of a graphical user interface.

### DETAILED DESCRIPTION

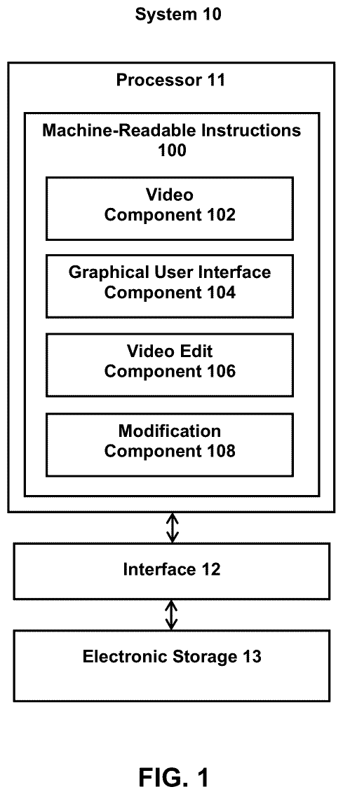

FIG. 1 illustrates a system 10 for presenting videos and video edits. The system 10 may include one or more of a processor 11, an interface 12 (e.g., bus, wireless interface), an electronic storage 13, and/or other components. Video information, video editing information, and/or other information may be obtained by the processor 11. The video information may define a video having a video progress length. The video edit information may define a video edit of the video. The video edit may include a segment of the video progress length. The video edit may have a video edit progress length. A graphical user interface may be presented by the processor 11. The graphical user interface may include a video timeline element and/or other elements. The video timeline element may represent the video progress length. The graphical user interface may be modified by the processor 11 to add a video edit timeline element. The video edit timeline element may represent the video edit progress length.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store video information, information relating to a video, video edit information, information relating to a video edit, information relating to a graphical user interface, information relating to modification of the graphical user interface, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate presenting videos and video edits. The machine-readable instructions 100 may include one or more computer program components. The machine-readable instructions 100 may include one or more of a video component 102, a graphical user interface component 104, a video edit component 106, a modification component 108, and/or other computer program components.

The video component 102 may be configured to obtain video information and/or other information. The video information component 102 may be configured to obtain video information and/or other information. Obtaining video information may include one or more of accessing, acquiring, analyzing, capturing, determining, examining, generating, identifying, loading, locating, opening, receiving, retrieving, reviewing, selecting, storing, and/or otherwise obtaining the video information. The video information component 102 may obtain video information from one or more locations. For example, the video information component 102 may obtain video information from a storage location, such as the electronic storage 13, electronic storage of information and/or signals generated by one or more sensors, electronic storage of a device accessible via a network, and/or other locations. The video information component 102 may obtain video information from one or more hardware components (e.g., an image sensor, a processor) and/or one or more software components (e.g., software running on a computing device).

In some implementations, the video component 102 may obtain video information based on user interaction with a user interface/application (e.g., video editing application, video player application), and/or other information. For example, a user interface/application may provide option(s) for a user to edit videos. The video information for a video may be obtained based on the user's selection of the video through the user interface/video application. Other selections of a video for retrieval of video information are contemplated.

The video information may define one or more videos. A video may have a video progress length. The video progress length of a video may be defined in terms of time durations and/or frame numbers. For example, a video may have a time duration of 60 seconds. A video may have 1800 video frames. A video having 1800 video frames may have a play time duration of 60 seconds when viewed at 30 frames per second. Other video progress lengths, time durations, and frame numbers are contemplated.

Content of one or more videos may be referred to as video content. Video content may include visual content, audio content, and/or other content. For example, video content may include visual content viewable as a function of progress through the video progress length of the video content, audio content playable as a function of progress through the video progress length of the video content, and/or other content that may be played back as a function of progress through the video progress length of the video content.

Visual content may refer to content of image(s), video frame(s), and/or video(s) that may be consumed visually. For example, visual content may be included within one or more images and/or one or more video frames of a video. The video frame(s) may define/contain the visual content of the video. That is, video may include video frame(s) that define/contain the visual content of the video. Video frame(s) may define/contain visual content viewable as a function of progress through the video progress length of the video content. A video frame may include an image of the video content at a moment within the video progress length of the video. As used herein, term video frame may be used to refer to one or more of an image frame, frame of pixels, encoded frame (e.g., I-frame, P-frame, B-frame), and/or other types of video frame. Visual content may be generated based on light received within a field of view of a single image sensor or within fields of view of multiple image sensors.

Visual content (of image(s), of video frame(s), of video(s)) with a field of view may be captured by an image capture device during a capture duration. A field of view of visual content may define a field of view of a scene captured within the visual content. A capture duration may be measured/defined in terms of time durations and/or frame numbers. For example, visual content may be captured during a capture duration of 60 seconds, and/or from one point in time to another point in time. As another example, 1800 images may be captured during a capture duration. If the images are captured at 30 images/second, then the capture duration may correspond to 60 seconds. Other capture durations are contemplated.

Visual content may be stored in one or more formats and/or one or more containers. Information defining visual content (visual information) may be stored within a single file or multiple files. For example, visual information defining an image or video frames of a video may be stored within a single file (e.g., image file, video file), multiple files (e.g., multiple image files, multiple video files), a combination of different files, and/or other files. In some implementations, visual information may be stored within one or more visual tracks of a video.

Audio content may refer to media content that may be consumed as one or more sounds. Audio content may include one or more sounds stored in one or more formats/containers, and/or other audio content. Audio content may include one or more sounds captured by one or more sound sensors (e.g., microphone). Audio content may include audio/sound captured during the capture of the visual content and/or audio/sound provided as an accompaniment for the visual content. Audio content may include one or more of voices, activities, songs, music, and/or other audio/sounds. Audio content may include sounds captured by a single sound sensor or an array of sound sensors. The audio content may be captured by one or more sound sensors of the image capture device (e.g., microphone(s) of and/or coupled to the image capture device) and/or may be captured by one or more sound sensors separate from the image capture device (e.g., microphone(s) separate from the image capture device).

Audio content may be stored in one or more formats and/or one or more containers. Information defining audio content (audio information) may be stored within a single file or multiple files. For example, audio information defining sound recorded with frames of a video may be stored within a single file (e.g., audio file, video file), multiple files (e.g., multiple audio files, multiple video files), a combination of different files, and/or other files. Audio information may be stored with and/or separate from the video information. In some implementations, audio information may be stored within one or more audio tracks of a video.

The video information may define a video by including information that defines one or more content, qualities, attributes, features, and/or other aspects of the video/video content. For example, the video information may define video content by including information that makes up the content of the video and/or information that is used to determine the content of the video. For instance, the video information may include information that makes up and/or is used to determine the arrangement of pixels, characteristics of pixels, values of pixels, and/or other aspects of pixels that define visual content of the video. The video information may include information that makes up and/or is used to determine audio content of the video. Other types of video information are contemplated.

In some implementations, the video content may include spherical video content. The field of view of the visual content of spherical video content may include a spherical field of view. Spherical field of view may include full spherical field of view (360 degrees of capture) or partial spherical field of view (less than 360 degrees of capture). The visual content may be viewable from a point of view as the function of progress through the progress length. Spherical video content may include and/or may be associated with spatial audio content.

Video information may be stored within a single file or multiple files. For example, video information defining a video may be stored within a video file, multiple video files, a combination of different files (e.g., a visual file and an audio file), and/or other files. Video information may be stored in one or more formats or containers. A format may refer to one or more ways in which the information defining a video is arranged/laid out (e.g., file format). A container may refer to one or more ways in which information defining a video is arranged/laid out in association with other information (e.g., wrapper format).

The graphical user interface component 104 may be configured to present one or more graphical user interfaces on one or more displays. A display may refer to an electronic device that provides visual presentation of information. A display may be configured to present visual content, graphical user interface(s), and/or other information. In some implementations, a display may include a touchscreen display. A touchscreen display may be configured to receive user input via a user's engagement with the touchscreen display. A user may engage with the touchscreen display via interaction with one or more touch-sensitive surfaces/screens and/or other components of the touchscreen display. A display may be a standalone device or a component of a computing device, such as a display of a mobile device (e.g., camera, smartphone, smartwatch, tablet, laptop) or a desktop device (e.g., touch monitor). User interaction with elements of the graphical user interface(s) may be received through the display (e.g., touchscreen display) and/or other user interface devices (e.g., keyboard, mouse, trackpad).

In some implementations, the visual content of video/video edit may be presented on the display(s). In some implementations, the visual content of video/video edit may be within the graphical user interface(s). In some implementations, one or more lower fidelity versions of the visual content may be generated for presentation. A lower fidelity version of the visual content may refer to a version (e.g., copy) of the visual content that is reproduced with less quality than the original visual content. For example, a lower fidelity version of the visual content may include a lower resolution version of the visual content, a lower framerate version of the visual content, and/or other lower-quality version of the visual content.

A graphical user interface may refer to a user interface that enables a user to interact with the system 10 through one or more interface elements. A graphical user interface may refer to a user interface that enables the system 10 to provide information to a user through one or more interface elements. A graphical user interface may include interface elements. A graphical user interface may be static or dynamic. A graphical user interface may include a static configuration of interface elements and/or include dynamic configurations of interface elements that changes (e.g., with time, based on user interaction with one or more interface elements). Multiple/different interface elements may be presented/included within a graphical user interface at the same time, may be presented/included within a graphical user interface at different times, and/or may be presented/included within a graphical user interface responsive to user interaction with one or more other interface elements and/or other information.

An interface element may refer to a graphical element of the user interface, such as window, icon, button, graphic, and/or other visual indicator. An interface element may visually provide information and/or enable a user to provide inputs to the system 10. For example, an interface element may visually provide information determined by the system 10 and/or a user may interact (e.g., engage, toggle, manipulate) with an interface element to provide one or more input to the system 10. A graphical user interface may facilitate interaction of the user with one or more of the interface elements via the user input received through one or more user interface devices (e.g., touchscreen display, keyboard, mouse, trackpad) and/or other user input. For example, a graphical user interface may present/include the interface elements in a particular arrangement and enable the user to interact with individual interface elements by engaging with locations corresponding to the individual interface elements on a touchscreen display.

A graphical user interface may include interface elements that convey information relating to a video/video edit. Information relating to a video/video edit may refer to information relating to content of the video/video edit, information relating to the video from which the video edit is generated, information relating to generation of the video edit from the video, information relating to usage of the video edit (e.g., presentation of the video edit, storage of the video edit), and/or other information relating to the video/video edit.

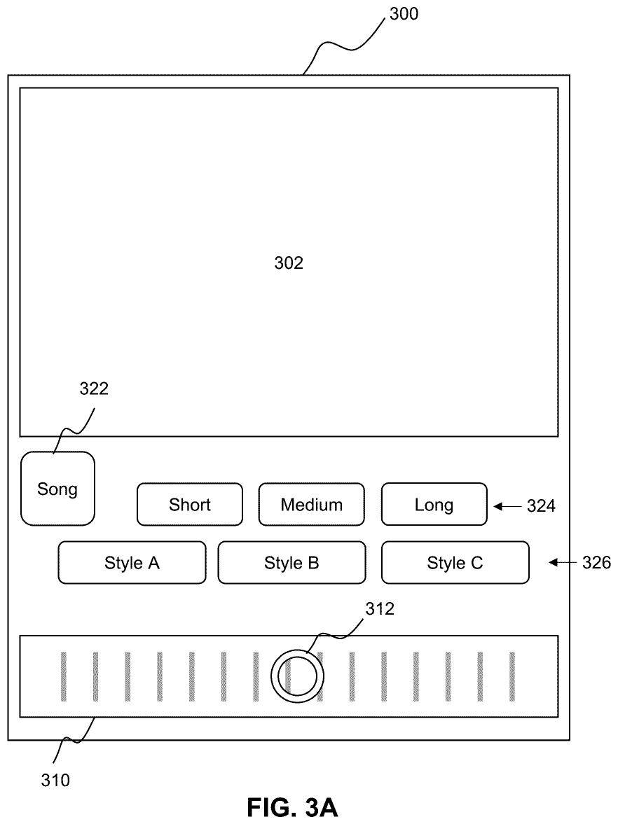

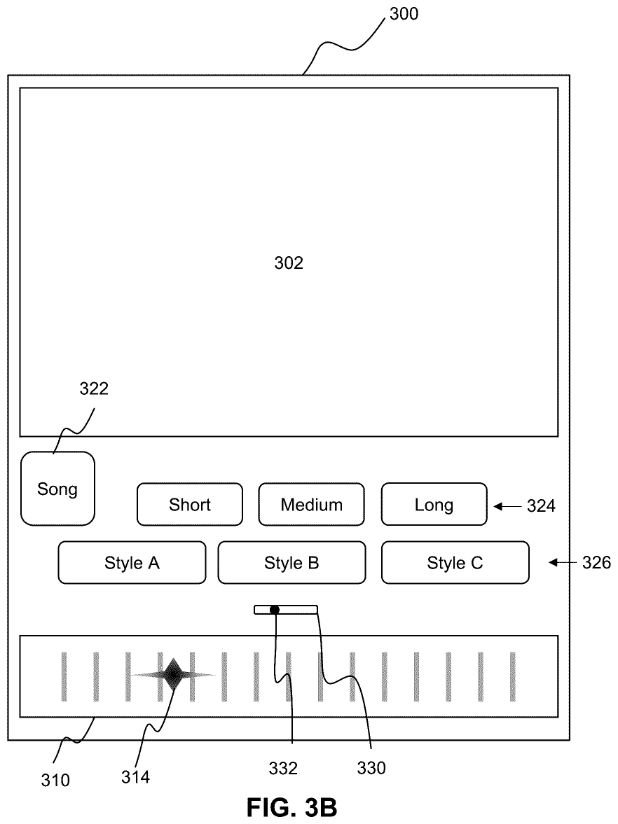

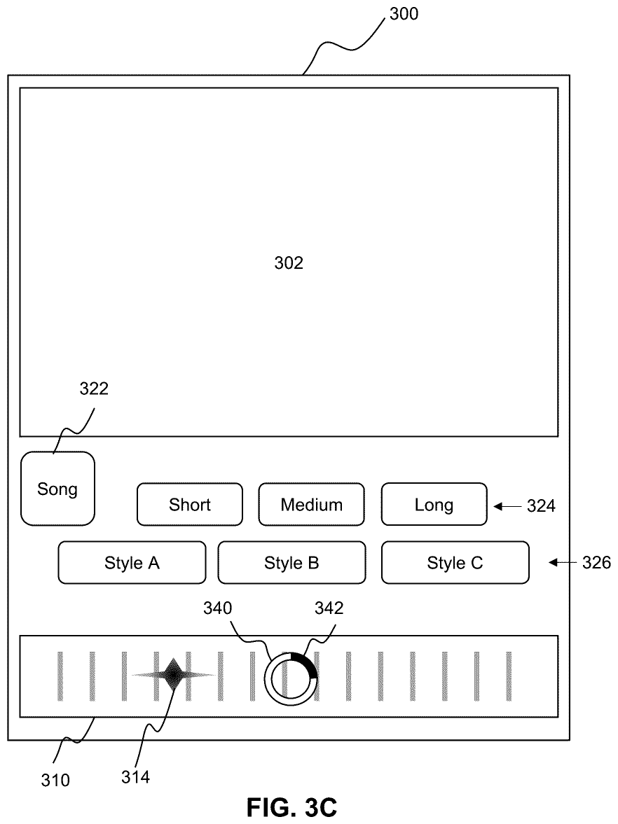

FIGS. 3A, 3B, and 3C, illustrate example views of a graphical user interface 300. The views of the graphical user interface 300 in FIGS. 3A, 3B, and 3C are provided merely as examples, and the arrangement and visual aspects of the graphical user interface may vary depending on the implementation. In some implementations, the graphical user interface may include additional features and/or alternative features. In some implementations, the graphical user interface may not include features shown in FIGS. 3A, 3B, and/or 3C. Other graphical user interfaces are contemplated.

Referring to FIG. 3A, the graphical user interface 300 may include a preview section 302. The preview section 302 may include presentation of visual content (visual content of video(s), visual content of a video edit). The graphical user interface 300 may include a video timeline element 310. The video timeline element may refer to an interface element that visually represents the video progress length of a video. The video timeline element 310 may represent the video progress length of a video. The video timeline element 310 may include timeline representation of the video progress length. For example, in FIG. 3A, the video timeline element 310 may include vertical lines that represent different parts of the video progress length. A user may interact with the vertical lines (e.g., select/move vertical lines within the video timeline element 310) to view/edit different parts of the video progress length.

In some implementations, only a portion of the video progress length of the video (e.g., zoomed in portion of the progress length) may be represented at a time by the video timeline element 310. In some implementations, the entire video progress length of the video may be represented at a time by the video timeline element 310.

In some implementations, the graphical user interface 300 may include one or more interface elements to enable generation of a video edit from a video. A user may interact with one or more of such interface elements to provide inputs to the system 10 on how a video edit is to be generated from a video. For example, in FIG. 3A, the graphical user interface may include a selection element 312, a music element 322, a video edit duration element 324, a video edit style element 326, and/or other interface elements.

The selection element 312 may enable user selection of part(s) of the video progress length for inclusion in the video edit. The selection element 312 may enable a user to select one or more parts (e.g., points, durations) of the video progress length of the video for use in generating the video edit. For example, a user may interact with the timeline representation within the video timeline element 310 to see different parts of the video progress length. The time point of the video being presented within the preview section 302 may be centered in the video timeline element 310. The selection element 312 may be positioned above the time point of the video being presented within the preview section 302. The user may interact with (e.g., press) the selection element 312 to select the part of the video progress length for use in generating the video edit. For example, responsive to user interaction with the selection element 312, the time point of the video progress length over which the selection element 312 is positioned may be marked as a highlight moment. Other selection of part(s) of the video progress length for user in generating the video edit is contemplated.

The music element 322 may enable user selection of music for the video edit. The music element 322 may enable a user to select a piece of music (e.g., song, soundtrack) to be used in the video edit. The music element 322 may enable a user to select a piece of music to provide accompaniment for the video edit. For example, responsive to user interaction with the music element, the user may be presented with a listing of music that is available for selection. The user may select a particular piece of music to be used with the video edit.

The video edit duration element 324 may enable user selection of a video edit progress length. The video edit progress length may refer to the progress length (e.g., duration) of the video edit. The video edit duration element 324 may enable a user to select how long of a video edit is to be generated from the video. The video edit duration element 324 may enable a user to specify the exact length of the video edit progress length and/or enable a user to select from options for different progress lengths (e.g., preset progress lengths). For example, in FIG. 3A, the video edit duration element 324 may enable a user to select between a short duration, a medium duration, and a long duration for the video edit, with the length of different durations being predefined (e.g., set within the system 10, preset by the user, predefined based on music selection).

The video edit style element 326 may enable user selection of a video edit style to create the video edit. The video edit style element 326 may enable a user to select the style of editing. A video edit style may refer to a style used to generate a video edit from one or more videos. A video edit style may determine how a video/one or more parts of the video are manipulated to generate a video edit. A video edit style may determine how visual effects, audio effects, and/or other effects are used to generate a video edit. Use of different video edit styles may result in generation of different video edits from a video. For example, in FIG. 3A, the video edit style element 326 may enable a user to select video styles A, B, and C in generating a video edit. In some implementations, a user may interact with the video edit style element 326 to see other video edit styles. For example, in FIG. 3A, a user may push the video edit style element 326 to the left or right to see video edit styles that are currently not shown within the graphical user interface 300.

The graphical user interface 300 may include other interface elements to enable generation of a video edit from a video. For example, the graphical user interface 300 may include a random selection element that enables a moment in the video progress length to be randomly selected for use in generating the video edit. The graphical user interface 300 may include a speed element that enables a user to select the speed with which the parts of the video included in the video edit will be included/presented within the video edit. The graphical user interface 300 may include an export element enables a user to export (e.g., save, upload, share) the video edit. Other interface elements/options to generate video edits are contemplated.

The video edit component 106 may be configured to obtain video edit information and/or other information. Obtaining video edit information may include one or more of accessing, acquiring, analyzing, determining, examining, identifying, generating, loading, locating, opening, receiving, retrieving, reviewing, selecting, storing, and/or otherwise obtaining the video edit information. Obtaining the video edit information may include obtaining previously generated/determined video edit information. For example, the video edit information may be stored in a storage location, and the video edit information component 104 may obtain the video edit information from the storage location. Obtaining the video edit information may include generating/determining new video edit information. For example, the video edit information component 104 may use a video to generate a video edit of the video. For example, the video edit may be generated based on user interaction with one or more interface elements of the graphical user interface 300.

The video edit information may defining a video edit of one or more videos. The video edit may include one or more segments of the video progress length(s) of the video(s). The video edit may have a video edit progress length. The video edit progress length of a video edit may be defined in terms of time durations and/or frame numbers. A video edit of a video may refer to an arrangement and/or a manipulation of one or more segments of the video(s). A video edit of a video may include one or more segments of the video(s) that have been selected for use in generating the video edit. A segment of a video may include a point in time or a duration within the video progress length of the video. A segment of a video may include a single video frame or multiple video frames of the video.

The video edit information may define a video edit by including information that defines one or more content, qualities, attributes, features, and/or other aspects of the video edit. For example, the video edit information may define a video edit by including information that makes up the content of the video edit and/or information that is used to determine the content of the video edit. For instance, the video edit information may include information that makes up and/or is used to determine the arrangement and/or the manipulation of segment(s) of a video that make up the video edit, such as information that identifies and/or is used to identify which segments of the video are included in the video edit and/or the arrangement/manipulation of the segments in the video edit. Other types of video edit information are contemplated.

The video edit information may be stored within a single file or multiple files. For example, video edit information defining a video edit of a video may be stored within a video edit file, multiple video edit files, a combination of different files, and/or other files. The video edit information may be stored in one or more formats or containers.

The modification component 108 may be configured to modify the graphical user interface(s). Modifying a graphical user interface may include changing one or more parts of the graphical user interface. Modifying a graphical user interface may include adding one or more new interface elements to the graphical user interface, removing one or more existing interface elements from the graphical user interface, changing one or more existing interface elements within the graphical user interface, and/or otherwise modifying the graphical user interface. In some implementations, modifying a graphical user interface may include replacing an existing graphical user interface with a new graphical user interface.

A graphical user interface may be modified to present information relating to the video edit. For example, the graphical user interface may be modified to add a video edit timeline element. The video edit timeline element may refer to an interface element that visually represents the video edit progress length of a video edit. The video edit timeline element may represent the video edit progress length. In some implementations, only a portion of the video edit progress length of the video edit (e.g., zoomed in portion of the progress length) may be represented at a time by the video edit timeline element. In some implementations, the entire video edit progress length of the video edit may be represented at a time by the video timeline element.

For example, modification component 108 may modify the graphical user interface 300 from the view shown in FIG. 3A to the view shown in FIG. 3B, or from the view shown in FIG. 3A to the view shown in FIG. 3C. Other modification of the graphical user interface is contemplated.

In FIG. 3B, the graphical user interface 300 may have been modified to add a video edit timeline element 330 to the graphical user interface 300. The video timeline element 310 may include a bar of one size and the video edit timeline element 330 may include a bar of another size. The bar of the video edit timeline element 330 may be smaller than the bar of the video timeline element 310. In FIG. 3C, the graphical user interface 300 may have been modified to add a video edit timeline element 340 to the graphical user interface 300. The video timeline element 310 may include a single-direction bar, extending from left to right across the user interface 300, and the video edit timeline element 340 may include a circular bar. Other designs of the video timeline element and the video edit timeline element are contemplated.

In some implementations, the video edit timeline element may be positioned adjacent to (next to) the video timeline element within the graphical user interface. For example, the video edit timeline element may be positioned to the left, right, above, or below the video timeline element. For instance, in FIG. 3B, the video edit timeline element 330 may be positioned above the video timeline element 310. In some implementations, the video edit timeline element may be positioned inside the video timeline element. The video edit timeline element may be positioned entirely or partially within the video timeline element. For instance, in FIG. 3C, the video edit timeline element 340 may be positioned entirely within the video timeline element 310. Other positions of the video timeline element and the video edit timeline element are contemplated.

Such simultaneous inclusion of the video timeline element and the video edit timeline element may enable a user to see both representations of the video and the video edit at the same time. Such presentation of the video edit timeline element may allow the user to easily distinguish between the original video and the video edit generated from the video.

In some implementations, the graphical user interface may further include a segment element. A segment element may refer to an interface element that indicates (represents) a segment of the video(s) included in the video edit. A segment element may visually represent a segment of the video progress length that has been selected for use in generating a video edit. A segment element may visually represent a segment of the video progress length that has been included in a video edit. The segment element may be positioned with respect to the video timeline element to indicate location of the segment of the video progress length included in the video edit. The segment element may be positioned within, along, above, below, and/or otherwise with respect to the video timeline element to visually indicate a segment of the video progress length included in the video edit. The segment element may be positioned with respect to the video timeline element to visually mark/distinguish a segment of the video included in the video edit from other segment(s) of the video not included in the video edit. For example, in FIGS. 3B and 3C, a segment element 314 may be positioned inside the video timeline element 310, with the lateral position of the segment element 314 visually indicating the location of the segment of the video progress length that has been included in the video edit.

In some implementations, the segment element may visually indicate the length of the segment included in the video edit. For example, the size (e.g., width) of the segment element may reflect the length of the segment included in the video edit, with smaller size reflecting shorter length and larger size reflecting longer length. In some implementations, the segment element may not visually indicate the length of the segment included in the video edit. For example, the size of the segment element may be fixed, and may not change for different lengths of the video included in the video edit. In some implementations, the segment element may include a gradient of color. For example, in FIGS. 3B and 3C, the center of the segment element 314 may be darker/more saturated than the sides/edges of the segment element 314. Such visual characteristics of the segment element 314 may visually indicate that the actual segment of the video progress length used in the video edit may be flexible. For example, the gradient in the segment element 314 may indicate that the segment of the video progress length included in the video edit is somewhere within the gradient but may not necessarily extend all the way from the beginning of the gradient to the end of the gradient.

In some implementations, playback of the video edit may be indicated via the video edit timeline element. Playback of the video edit may include presentation of the video edit within the preview section 302. During playback of the video edit, the current moment of the video edit being presented within the preview section 302 may be indicated by a current moment element. The current moment element may visually indicate the current moment of the video edit being presented.

For example, in FIG. 3B, a current moment element 332 may move across the video edit timeline element 330 during playback of the video edit. The current moment element 332 may be located at the beginning (left terminal position) of the video edit timeline element 330 to reflect the play position at the beginning of the video edit progress length. The current moment element 332 may be located at the end (right terminal position) of the video edit timeline element 330 to reflect the play position at the end of the video edit progress length.

In FIG. 3C, a current moment element 342 may fill the video edit timeline element 340 during playback of the video edit. The video edit timeline element 340 may be empty to reflect the play position at the beginning of the video edit progress length. The video edit timeline element 340 may be completely filled to reflect the play position at the end of the video edit progress length.

The playback of the video edit may not be indicated via the video timeline element. That is, when both the video timeline element and the video edit timeline element are presented in the graphical user interface, the playback of the video edit may be indicated via the video edit timeline element and not the video timeline element. In some implementations, playback of the video may be reflected via the video timeline element. For example, a current moment element may move across the video timeline element 310 when the video is being played, and the current moment element 332 may move across the video edit timeline element 330 when the video edit is being played. Thus, playback of the video may be indicated via the video timeline element 310 while the playback of the video edit may be indicated via the video edit timeline element 330. Such indication of the video/video edit playback position may enable a user to easily determine whether the video or the video edit is being played.

In some implementations, the video edit timeline element may be interactable by a user to change playback of the video edit. For example, referring to FIG. 3B, a user may manipulate the position of the current moment element 332 along the video edit timeline element 330 to change which part of the video edit is being presented within the preview section 302.

In some implementations, the video edit timeline element may not be interactable by a user to change playback of the video edit. For example, referring to FIG. 3B, the position of the current moment element 332 along the video edit timeline element 330 may not be directly changed via user interaction with the current moment element 332. The current moment element 332 may change position along the video edit timeline element 330 during playback of the video edit, but a user may not directly move the current moment element 332 to alter video edit playback.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11 and the electronic storage 13 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11 is shown in FIG. 1 as a single entity, this is for illustrative purposes only. In some implementations, the processor 11 may comprise a plurality of processing units. These processing units may be physically located within the same device, or the processor 11 may represent processing functionality of a plurality of devices operating in coordination. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, in implementations in which processor 11 comprises multiple processing units, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system and/or removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

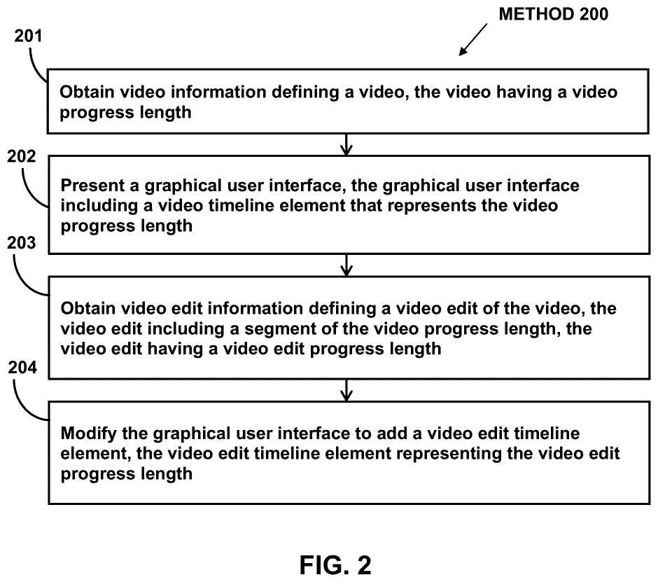

FIG. 2 illustrates method 200 for presenting videos and video edits. The operations of method 200 presented below are intended to be illustrative. In some implementations, method 200 may be accomplished with one or more additional operations not described, and/or without one or more of the operations discussed. In some implementations, two or more of the operations may occur simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage mediums. The one or more processing devices may include one or more devices configured through hardware, firmware, and/or software to be specifically designed for execution of one or more of the operations of method 200.

Referring to FIG. 2 and method 200, at operation 201, video information may be obtained. The video information may define a video having a video progress length. In some implementations, operation 201 may be performed by a processor component the same as or similar to the video component 102 (Shown in FIG. 1 and described herein).

At operation 202, a graphical user interface may be presented. The graphical user interface may include a video timeline element and/or other elements. The video timeline element may represent the video progress length. In some implementations, operation 202 may be performed by a processor component the same as or similar to the graphical user interface component 104 (Shown in FIG. 1 and described herein).

At operation 203, video editing information may be obtained. The video edit information may define a video edit of the video. The video edit may include a segment of the video progress length. The video edit may have a video edit progress length. In some implementations, operation 203 may be performed by a processor component the same as or similar to the video edit component 106 (Shown in FIG. 1 and described herein).

At operation 204, the graphical user interface may be modified to add a video edit timeline element. The video edit timeline element may represent the video edit progress length. In some implementations, operation 204 may be performed by a processor component the same as or similar to the modification component 108 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system for presenting videos and video edits, the system comprising:
one or more physical processors configured by machine-readable instructions to:
obtain video information defining the video, the video having a video progress length;
present a graphical user interface, the graphical user interface including a video timeline element that represents the video progress length;
obtain video edit information for the video, the video edit information defining the video edit of the video, the video edit including a segment of the video progress length, the video edit having a video edit progress length, wherein a segment element is positioned with respect to the video timeline element to visually indicate the segment of the video progress length included in the video edit and to visually indicate location of the segment of the video progress length included in the video edit; and
modify the graphical user interface to add a video edit timeline element, the video edit timeline element representing the video edit progress length;
wherein:
simultaneous inclusion of the video timeline element representing the video progress length and the video edit timeline element representing the video edit progress length enables a user to distinguish between playback of the video and playback of the video edit;
a current moment of the video being presented during the playback of the video is indicated by a first current moment element positioned along the video timeline element; and
a current moment of the video edit being presented during the playback of the video edit is indicated by a second current moment element positioned along the video edit timeline element and not by the first current moment element positioned along the video timeline element.

2. The system of claim 1, wherein:
the video timeline element includes a first bar and the video edit timeline element includes a second bar, the second bar smaller than the first bar, the first bar positioned adjacent to the second bar; or
the video timeline element includes a single-direction bar and the video edit timeline element includes a circular bar, the circular bar positioned inside the single-direction bar.

3. A system for presenting videos and video edits, the system comprising:
one or more physical processors configured by machine-readable instructions to:
obtain video information defining a video, the video having a video progress length;
present a graphical user interface, the graphical user interface including a video timeline element that represents the video progress length;
obtain video edit information defining a video edit of the video, the video edit including a segment of the video progress length, the video edit having a video edit progress length, wherein a segment element is positioned with respect to the video timeline element to visually indicate the segment of the video progress length included in the video edit; and
modify the graphical user interface to add a video edit timeline element, the video edit timeline element representing the video edit progress length;
wherein:
simultaneous inclusion of the video timeline element representing the video progress length and the video edit timeline element representing the video edit progress length enables a user to distinguish between playback of the video and playback of the video edit;
a current moment of the video being presented during the playback of the video is indicated by a first current moment element positioned along the video timeline element; and
a current moment of the video edit being presented during the playback of the video edit is indicated by a second current moment element positioned along the video edit timeline element.

4. The system of claim 3, wherein the video edit timeline element is positioned adjacent to the video timeline element.

5. The system of claim 3, wherein the video edit timeline element is positioned inside the video timeline element.

6. The system of claim 3, wherein the video timeline element includes a first bar and the video edit timeline element includes a second bar, the second bar smaller than the first bar.

7. The system of claim 3, wherein the video timeline element includes a single-direction bar and the video edit timeline element includes a circular bar.

8. The system of claim 3, wherein element to indicate the current moment of the video edit being presented during the playback of the video edit includes the second current moment element moving across the video edit timeline element or the second current moment element filling the video edit timeline element during the playback of the video edit.

9. The system of claim 3, wherein the graphical user interface further includes a video edit style element, the video edit style element enabling user selection of a video edit style to create the video edit.

10. The system of claim 3, wherein the graphical user interface further includes a video edit duration element, the video edit duration element enables user selection of the video edit progress length.

11. The system of claim 3, wherein the segment element visually indicates location of the segment of the video progress length included in the video edit.

12. A method for presenting videos and video edits, the method performed by a computing system including one or more processors, the method comprising:
obtaining, by the computing system, video information defining a video, the video having a video progress length;
presenting, by the computing system, a graphical user interface, the graphical user interface including a video timeline element that represents the video progress length;
obtaining, by the computing system, video edit information defining a video edit of the video, the video edit including a segment of the video progress length, the video edit having a video edit progress length, wherein a segment element is positioned with respect to the video timeline element to visually indicate the segment of the video progress length included in the video edit; and
modifying, by the computing system, the graphical user interface to add a video edit timeline element, the video edit timeline element representing the video edit progress length;
wherein:
simultaneous inclusion of the video timeline element representing the video progress length and the video edit timeline element representing the video edit progress length enables a user to distinguish between playback of the video and playback of the video edit;
a current moment of the video being presented during the playback of the video is indicated by a first current moment element positioned along the video timeline element; and
a current moment of the video edit being presented during the playback of the video edit is indicated by a second current moment element positioned along the video edit timeline element.

13. The method of claim 12, wherein the video edit timeline element is positioned adjacent to the video timeline element.

14. The method of claim 12, wherein the video edit timeline element is positioned inside the video timeline element.

15. The method of claim 12, wherein the video timeline element includes a first bar and the video edit timeline element includes a second bar, the second bar smaller than the first bar.

16. The method of claim 12, wherein the video timeline element includes a single-direction bar and the video edit timeline element includes a circular bar.

17. The method of claim 12, wherein the second current moment element being positioned along the video edit timeline element to indicate the current moment of the video edit being presented during the playback of the video edit includes the second current moment element moving across the video edit timeline element or the second current moment element filling the video edit timeline element during the playback of the video edit.

18. The method of claim 12, wherein the graphical user interface further includes a video edit style element, the video edit style element enabling user selection of a video edit style to create the video edit.

19. The method of claim 12, wherein the graphical user interface further includes a video edit duration element, the video edit duration element enables user selection of the video edit progress length.

20. The method of claim 12, wherein the segment element visually indicates location of the segment of the video progress length included in the video edit.
